(19) United States
(12) Patent Application Publication
(10) Pub. No.: US 2002/0035829 A1
(43) Pub. Date: Mar. 28, 2002

(54) Chain with utility and ornamental applications

(76) Inventor: Silvana Sorsi, Altavilla Vicentina (IT)

Correspondence Address: BUCKNAM AND ARCHER, Joseph J. Orlando, Atty., 600 Old Country Road, Garden City, NY, 11530, US

(21) Appl. No.: 09/949,593

(22) Filed: Sep. 10, 2001

(30) Foreign Application Priority Data
Sep. 28, 2000 (IT) VI2000A000212

(51) Int. Cl. F16G 15/00

(52) U.S. Cl. 59/93

(57) ABSTRACT

The chain for utility and ornamental applications is provided with an elastic element (1) capable of extending in the direction of the longitudinal development of the chain, in case there is an attempt of snatching exerted on the chain itself.

### FIELD OF THE INVENTION

The present invention relates to a chain with both utility and ornamental applications.

### BACKGROUND OF THE PRIOR ART

It is known that in the last few years there has been a definite increase of bag snatching and robberies carried out by road delinquents, particularly with people who are weak and/or not having a defense. This type of malfeasance which is by itself disdainful and abominable, is particularly hateful if one considers that the integrity and the health of the individual who endures the crime is endangered, as in the case of the bag snatching with the tearing of the purses and objects of personal use of the victim. Among these bag snatchings one must consider the type which consists of the snatching of the chains placed around the neck of the user, which in the great majority of cases are women.

This type of snatching, i.e. chain snatching, in addition to causing a substantial economical loss in the case in which the chain is constituted of gold or other precious metal, is capable of causing to the victim of the crime substantial psychological harm as well as physical harm, because the neck of the wearer undergoes true and clear trauma due to the fact that the delinquent necessarily exerts great pulling effort on the chains for the purpose of reaching the breaking point thereof. In some cases significant physical harm of the wearer occurs, above all in the case in which the snatching attempt occurs from behind which results in a choking action on the neck of the wearer.

### SUMMARY OF THE INVENTION

The object of the present invention is to provide a chain intended for utility and ornamental applications, capable of resisting, within wide limitations, the pulling or snatching action exerted by an individual who has bad intentions.

In addition, the individual who wishes to achieve this object must be capable of avoiding substantial interference with the aesthetic appearance of the same chain.

This object is achieved by providing in the chain the presence of an elastic element which is capable of extending in the direction of the longitudinal development of the chain in the case of a snatching attempt exerted on the chain. In view of this provision the pulling exertion on the chain causes at the most a weakening of the elastic element but the chain remains on the neck of the wearer, who in addition to other advantages, undergoes due to the presence of the elastic element, much less physical damage than the damage caused at present.

These and other characteristics of the invention will be described in detail by reference to a particular non-limiting embodiment shown in the attached drawings in which:

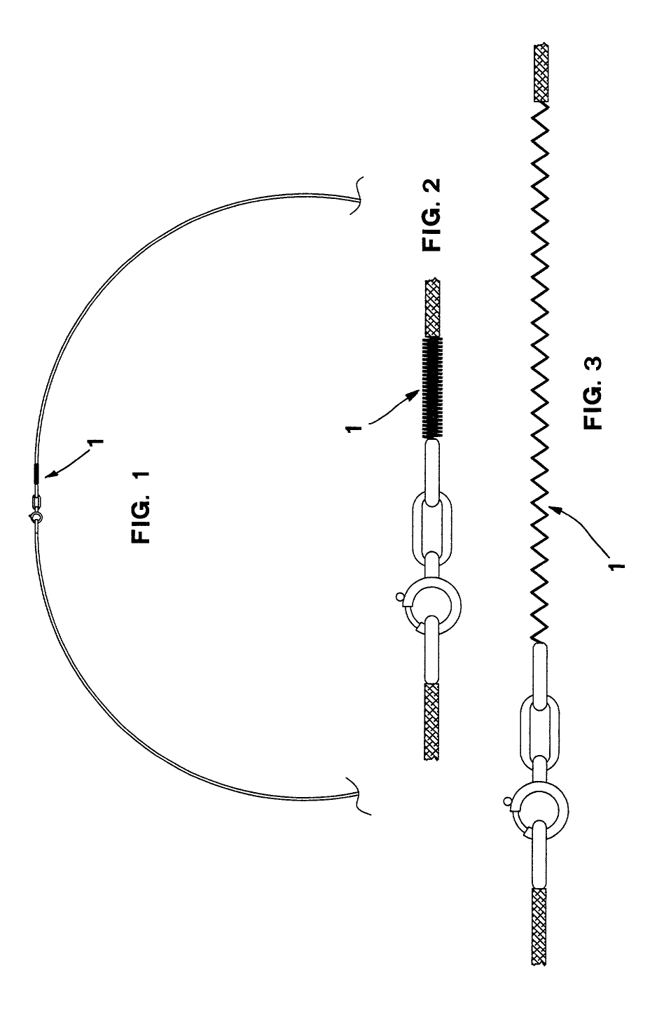

FIG. 1 shows a chain according to the invention;

FIGS. 2 and 3 show two enlarged views of the chain of the invention in the area in which the elastic element is present, respectively, before and after the effort to snatch the chain.

FIG. 1 shows the elastic element (1) which is capable of extending in the direction of the longitudinal development of the chain in the case in which an attempt is made to snatch or tear the chain. In actual practice in this case the elastic element (1) constituted advantageously by a normal spiral spring, extends in length when a pulling force is made on the chain during a snatching attempt. In this manner the chain exerts a high resistance to breaking and in every case absorbs the greater part of energy exerted by the individual who is attempting to snatch the chain, thus limiting substantially the injuries undergone by the neck of the individual who wears the chain. Naturally, the elastic element will be weakened by carrying out an irreversible lengthening according to the effort exerted.

In this manner the wearer, in addition to having reduced the damages to the body, would be able in the majority of cases to keep the chain which may be repaired so that use may be continued.

The proportions and the geometry of the spring are very diversified and conform to the model of the chain, that is whether the chain is to be used around the neck or for a bracelet, or as an ankle support. By way of a non-limiting example, the length of the elastic element may vary between 4 mm up to a few centimeters. Naturally, with equal pulling force on the chain a lengthening will develop which will depend both on the length and the diameter of the elastic element. By way of example, a test has been carried out with an elastic element of 6 mm length with a diameter of 0.35 mm and diameter of the wire of the spiral spring of 0.25 mm which has caused a variable lengthening depending on the force being exerted, between 6 mm and 4 cm.

In every case it is noted that by means of the device according to the present invention the user has the guarantee of an element capable of achieving the objects mentioned hereinabove. The elastic element may be made of any metal, precious or not precious.

What is claimed is:

1. A chain for utility and ornamental applications, characterized by the fact that it is provided with an elastic element (1) capable of extending in the direction of longitudinal development of the chain in case there is an attempt of snatching exerted on the chain itself.

2. The chain according to claim 1 characterized by the fact that the elastic element is constituted by a spiral spring.
